(19) United States
(12) Patent Application Publication
(10) Pub. No.: US 2023/0311878 A1
(43) Pub. Date: Oct. 5, 2023

(54) VEHICLE AND CONTROL METHOD FOR VEHICLE

(71) Applicant: TOYOTA JIDOSHA KABUSHIKI KAISHA, Toyota-shi (JP)

(72) Inventor: Hayato SHIRAI, Tagata-gun (JP)

(73) Assignee: TOYOTA JIDOSHA KABUSHIKI KAISHA, Toyota-shi (JP)

(21) Appl. No.: 18/329,768

(22) Filed: Jun. 6, 2023

(30) Foreign Application Priority Data
Aug. 4, 2022 (JP) 2022-124795

(51) Int. Cl. B60W 30/16

(52) U.S. Cl. CPC B60W 30/16; B60W 2720/106; B60W 2754/30

(57) ABSTRACT

A vehicle is provided with a control device configured to control a vehicle behavior for driver assistance or automated driving. The control device is configured to set the driving mode at the time of tracking based on the target following distance at the time of tracking making the host vehicle follow a tracked object at the time of driver assistance or the time of automated driving when performing that tracking and to set it to a driving mode by which the allowable range of the acceleration degree at the time of acceleration or deceleration is expanded at least at one of the upper limit side and lower limit side when the set value of the target following distance is small compared to when it is large.

### CROSS-REFERENCE TO RELATED APPLICATION

This application claims priority to Japanese Patent Application No. 2022-124795 filed on Aug. 4, 2022, incorporated herein by reference in its entirety.

### FIELD

The present disclosure relates to a vehicle and a control method for a vehicle.

### BACKGROUND

Japanese Unexamined Patent Publication No. 5-141285 discloses a vehicle control device calculating a target following distance based on a vehicle speed for tracking for following a preceding vehicle and controlling acceleration and deceleration of a host vehicle.

### SUMMARY

If making a host vehicle track a preceding vehicle, it is possible to reduce the air resistance of the host vehicle. For this reason, it is possible to reduce the amount of energy consumed by the host vehicle (amount or fuel consumption or amount of power consumption) and increase the cruising distance of the host vehicle.

The effect of improvement of the fuel economy due to this reduction of the air resistance becomes lower the larger the distance to the preceding vehicle. For this reason, it is desirable to reduce the following distance as much as possible at the time of tracking. However, for this purpose, when the preceding vehicle has decelerated, to prevent collision with the preceding vehicle, it is necessary to get the user of the vehicle to accept deceleration with a large degree of deceleration. Further, when, at the time of tracking, when the preceding vehicle accelerates and the following distance to the preceding vehicle becomes larger than the target following distance, it is desirable to return the following distance to the target following distance as quickly as possible. However, for this purpose, it is necessary to get the user of the vehicle to accept acceleration with a large degree of acceleration.

In this way, to raise the effect of improvement of the fuel economy due to reduction of the air resistance, it is necessary to permit at least one of acceleration with a large acceleration degree and deceleration with a large deceleration degree at the time of tracking. However, if permitting such acceleration and deceleration, the riding comfort of the vehicle deteriorates. Further, among users of vehicles, there may also be persons who emphasize riding comfort over the effect of improvement of fuel economy through reduction of the air resistance even at the time of tracking. Further, depending on the circumstance, it is considered that sometimes riding comfort is desired to be emphasized.

Therefore, it is necessary to suitably control the vehicle behavior at the time of tracking so as to become vehicle behavior giving an effect which a vehicle user emphasizes.

The present disclosure was made focusing on such a problem and has as its object to be able to suitably control a vehicle behavior at the time of tracking so as to become vehicle behavior giving an effect which a vehicle user emphasizes.

To solve this problem, a vehicle according to one aspect of the present disclosure is provided with a control device configured to control a vehicle behavior for driver assistance or automated driving. Further, the control device is configured to set the driving mode at the time of tracking based on the target following distance at the time of tracking making the host vehicle follow a tracked object at the time of driver assistance or the time of automated driving when performing that tracking and to set it to a driving mode by which the allowable range of the acceleration degree at the time of acceleration or deceleration is expanded at least at one of the upper limit side and lower limit side when the set value of the target following distance is small compared to when it is large.

Further, a control method for a vehicle by a control device configured to control a vehicle behavior for driver assistance or automated driving according to one aspect of the present disclosure includes setting the driving mode at the time of tracking based on the target following distance at the time of tracking making the host vehicle follow a tracked object at the time of driver assistance or the time of automated driving when performing that tracking and setting the driving mode to a driving mode by which the allowable range of the acceleration degree at the time of acceleration or deceleration is expanded at least at one of the upper limit side and lower limit side when the set value of the target following distance is small compared to when the target following distance is large.

According to these aspects of the present disclosure, when the target following distance at the time of tracking is small, that is, when the vehicle user emphasizes the effect of improvement of fuel economy by reduction of the air resistance over the riding comfort of the vehicle, the driving mode is set to one by which the allowable range of the acceleration degree at the time of acceleration or deceleration is expanded at least at one of the upper limit side and lower limit side. For this reason, it is possible to suitably control a vehicle behavior at the time of tracking so as to become vehicle behavior giving an effect which a vehicle user emphasizes.

### BRIEF DESCRIPTION OF DRAWINGS

FIG. 1 is a schematic view of the system configuration of a vehicle according to one embodiment of the present disclosure.

FIG. 2 is a flow chart for explaining processing for setting a driving mode according to one embodiment of the present disclosure.

### DESCRIPTION OF EMBODIMENTS

Below, referring to the drawings, embodiments will be explained in detail. Note that in the following explanation, similar constituent elements will be assigned the same reference numerals.

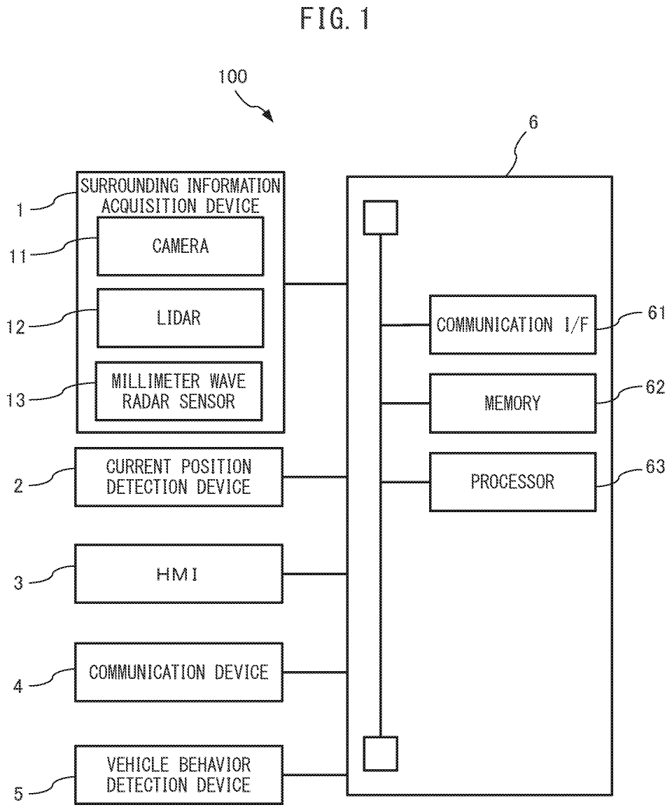

FIG. 1 is a schematic view of the system configuration of a vehicle 100 according to one embodiment of the present disclosure.

As shown in FIG. 1, the vehicle according to the present embodiment 100 is provided with a surrounding information acquisition device 1, current position detection device 2, human machine interface (below, referred to as the “HMI”), communication device 4, vehicle behavior detection device 5, and electronic control unit 6. The surrounding information acquisition device 1, current position detection device 2, HMI 3, communication device 4, and vehicle behavior detection device 5 are electrically connected through an internal vehicle network based on the CAN (controller area network) or other standard to the electronic control unit 6.

The surrounding information acquisition device 1 is a device for acquiring information relating to the surrounding environment of the host vehicle (below, referred to as the “vehicle surrounding information”). The vehicle surrounding information acquired by the surrounding information acquisition device 1 is sent through the internal vehicle network to the electronic control unit 6. The surrounding information acquisition device 1 can be comprised of one or more pieces of equipment. For example, it can be comprised of a camera, LIDAR (light detection and ranging device), millimeter wave radar sensor, ultrasonic sensor, etc.

In the present embodiment, as the surrounding information acquisition device 1, a camera 11 for capturing the surroundings of the host vehicle, a LIDAR 12 for using laser beams to detect objects such as other vehicles in the surroundings of the host vehicle, and a millimeter wave radar sensor 13 for detecting objects in the surroundings of the host vehicle over a far distance from the LIDAR 12 utilizing radio waves.

The current position detection device 2 is a device for detecting the position of the host vehicle (for example, the longitude and latitude of the vehicle). As the current position detection device 2, for example, a GNSS receiver for detecting the current position based on satellite signals received from a plurality of satellites etc. may be mentioned, but the disclosure is not limited to this. The vehicle current position detected by the current position detection device 2 is sent through the internal vehicle network to the electronic control unit 6.

The HMI 3 is an interface for inputting and outputting information between the vehicle 100 and its user (for example, driver or passengers, outside operator of vehicle, etc.) The HMI 3 is provided with an output device for outputting information to be provided to the vehicle user and an input device for the vehicle user to perform various input operations. As the output device, for example, a display or speaker, vibration unit, etc. may be mentioned. As the input device, for example, a touch panel or operating buttons, operating switches, microphone, etc. may be mentioned. The HMI 3 provides the output information received from the electronic control unit 6 through the internal vehicle network to the user of the vehicle through the output device. Further, the HMI 3 sends the input information input through the input device through the internal vehicle network to the electronic control unit 6.

Note that, the HMI 3 can be mounted in advance in the vehicle 100. Also, a terminal owned by the vehicle user (for example, a smart phone, tablet, PC, etc.) can be connected by a cable or wirelessly with the electronic control unit 6 and that terminal be made to function as the HMI 3.

In the present embodiment, to enable the vehicle behavior at the time of driving the vehicle to change, the electronic control unit 6 is able to set the driving mode of the vehicle 100 to any driving mode automatically or manually by the user of the vehicle through the HMI 3. Specifically, in the present embodiment, as the driving mode of the vehicle 100, any driving mode can be selected from among the two driving modes of at least the first driving mode and the second driving mode.

The first driving mode is, for example, a driving mode which prioritizes riding comfort or other comfort. In other words, the first driving mode is a driving mode in the allowable range of the acceleration degree at the time of acceleration or deceleration, which is limited to a relatively narrow range. The upper limit value of the allowable range (positive value) is the upper limit value of the acceleration degree allowed at the time of acceleration. The lower limit value of the allowable range (negative value) is the lower limit value of the acceleration degree allowed at the time of deceleration, in other words, the upper limit value of the deceleration degree allowed at the time of deceleration.

By limiting the allowable range of the acceleration degree at the time of acceleration or deceleration to a narrow range in this way, the vehicle is no longer accelerated by a large acceleration degree or decelerated by a large deceleration degree at the time of driver assistance or the time of automated driving, so it is possible to keep the riding comfort of the vehicle from deteriorating.

The second driving mode is, for example, a driving mode which prioritizes acceleration performance etc. and a driving mode by which the allowable range of the acceleration degree at the time of acceleration or deceleration is expanded compared with the first driving mode.

Due to this, by setting the driving mode to the second driving mode, when making a host vehicle track a preceding vehicle at the time of driver assistance or the time of automated driving, even if the preceding vehicle accelerates and the following distance to the preceding vehicle temporarily becomes larger than the target following distance, it is possible to accelerate with a large acceleration degree to quickly return the following distance to the target following distance. Further, when the preceding vehicle has decelerated as well, it is possible to decelerate with a large deceleration degree, so compared with the time of the first driving mode, it is possible to set the value of the target following distance to a small value.

The communication device 4 is a device for communicating with the outside of the vehicle. The communication device 4 is provided with a wide area communicator for communicating with the outside of the vehicle through a wireless communication network and a narrow area communicator for direct communication with terminals (for example, vehicle-to-vehicle, road-to-vehicle, and pedestrian-vehicle).

The vehicle behavior detection device 5 detects parameters showing the behavior of the vehicle 100 (below, referred to as the “vehicle behavior information”). The vehicle behavior information detected by the vehicle behavior detection device 5 is sent through the internal vehicle network to the electronic control unit 6. As the vehicle behavior detection device 5, for example, a vehicle speed sensor or acceleration degree sensor, steering angle sensor, etc. may be mentioned. As the vehicle behavior information, the vehicle speed, acceleration degree, steering angle, etc. detected by these sensors may be mentioned.

The electronic control unit 6 is provided with a communication interface (communication I/F) 61, memory 62, and processor 63.

The communication interface 61 is provided with an interface circuit for connecting the electronic control unit 6 to the internal vehicle network. The electronic control unit 6 is connected through the communication interface 61 to the above-mentioned surrounding information acquisition device 1 or other of the various vehicle-mounted equipment.

The memory 62 has an HDD (hard disk drive) or optical recording medium, semiconductor memory, or other storage medium. The memory 62 stores the various computer programs and data etc. used in the processor 63. Further, the memory 62 stores the data generated by computer programs, data received from various vehicle-mounted equipment through the communication interface 61, etc.

The processor 63 is provided with one or more CPUs (central processing unit) and their peripheral circuits. The processor 63 performs various processing based on various computer programs stored in the memory 62.

For example, the processor 63 prepares a driving plan of a host vehicle at the time of driver assistance or the time of automated driving based on the vehicle surrounding information, vehicle behavior information, etc. and automatically performs driving operations relating to acceleration, steering, and braking in accordance with the driving plan so as to perform tracking following the preceding vehicle. As the tracking, adaptive cruise control (ACC) by which driving operations relating to acceleration and braking are automatically performed so that the following distance with the preceding vehicle is maintained constant, platooning by which driving operations relating to acceleration, steering, and braking are automatically performed so as to maintain the following distance with the preceding vehicle constant while enabling a lane change matching a lane change of a preceding vehicle or so as to track the preceding vehicle while matching the position of the preceding vehicle in the lane, etc. may be mentioned.

As explained above, by tracking, it is possible to reduce the air resistance of the host vehicle. As a result, it is possible to reduce the amount of energy consumed by the host vehicle (amount of fuel consumed or amount of power consumed) and increase the cruising distance of the host vehicle. In particular, by tracking the preceding vehicle while following the position of the preceding vehicle in the lane like with platooning (that is, by tracking the preceding vehicle while also controlling the vehicle behavior to the left and right in the lane), it is possible to more effectively reduce the air resistance of the host vehicle. Further, the effect of improvement of fuel economy due to this reduction of the air resistance tends to become higher when the following distance from the preceding vehicle is small compared to when it is large.

Therefore, during tracking, it is desirable to set the following distance from the preceding vehicle to as small a value as possible. However, for this reason, to prevent collision with the preceding vehicle when the preceding vehicle has decelerated, it is necessary to get the vehicle user to allow deceleration with a large deceleration degree. Further, when the preceding vehicle accelerates and the following distance to the preceding vehicle becomes larger than the target following distance at the time of tracking, it is desirable to return the following distance to the target following distance as quickly as possible. However, for this reason, it is necessary to get the vehicle user to allow acceleration with a large acceleration degree.

In this way, to raise the effect of improvement of fuel economy due to reduction of the air resistance, it is necessary to accept at least one of acceleration with a large acceleration degree and deceleration with a large deceleration degree to be performed at the time of tracking. However, if allowing such acceleration and deceleration, the riding comfort of the vehicle 100 deteriorates. Further, among the vehicle users, it is considered that there may be ones who emphasize riding comfort rather than the effect of improvement of fuel economy due to the reduction of the air resistance even at the time of tracking. Further, usually it may be considered that even a vehicle user emphasizing the effect of improvement of fuel economy due to reduction of the air resistance will sometimes emphasize riding comfort depending on the situation.

Therefore, it is necessary to suitably control the vehicle behavior at the time of tracking so that the effect which the vehicle user emphasizes is obtained.

Therefore, when the set value of the target following distance at the time of tracking is small, it is considered that the vehicle user is emphasizing the effect of improvement of fuel economy due to reduction of the air resistance over riding comfort. On the other hand, when the vehicle user increases the set value of the target following distance at the time of tracking, it is considered that the user desires tracking not requiring rapid acceleration or deceleration, that is, tracking emphasizing riding comfort.

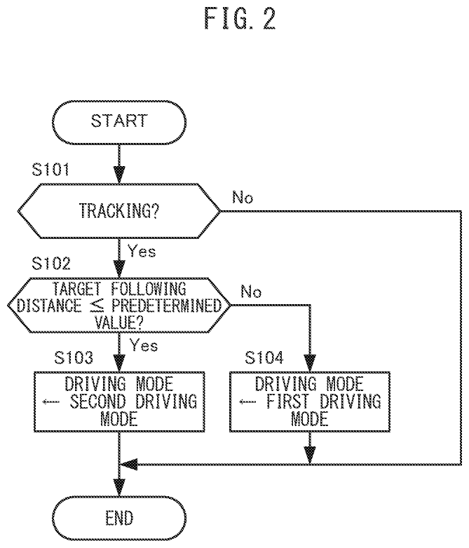

Therefore, in the present embodiment, a driving mode during tracking was set based on the target following distance during tracking. Below, referring to FIG. 2, the content of the processing for setting the driving mode according to the present embodiment performed by the processor 63 and in turn the electronic control unit 6 will be explained next. The electronic control unit 6 repeatedly performs the present processing while the vehicle is running at predetermined processing cycles.

At step S101, the electronic control unit 6 judges whether the vehicle is tracking at the time of driver assistance or the time of automated driving. If tracking, the electronic control unit 6 proceeds to the processing of step S102. On the other hand, if not tracking, the electronic control unit 6 ends the current processing.

At step S102, the electronic control unit 6 judges whether the set value of the target following distance is less than or equal to a predetermined value. In the present embodiment, the predetermined value is made the shortest distance among the following distances which can be set as the target following distance. The set value of the target following distance can be changed by the user of the host vehicle through the HMI 3. If the set value of the target following distance is less than or equal to the predetermined value, the electronic control unit 6 proceeds to the processing of step S103. On the other hand, if the set value of the target following distance is larger than the predetermined value, the electronic control unit 6 proceeds to the processing of step S104.

At step S103, the electronic control unit 6 sets the driving mode to the second driving mode.

At step S104, the electronic control unit 6 sets the driving mode to the first driving mode.

The vehicle 100 according to the present embodiment explained above is provided with an electronic control unit 6 (control device) controlling the vehicle behavior for driver assistance or automated driving. Further, the electronic control unit 6 is configured to set the driving mode at the time of tracking based on the target following distance at the time of tracking when performing tracking making the host vehicle track the preceding vehicle (tracked object) at the time of driver assistance or the time of automated driving and to set it to a driving mode expanded in at least one of an upper limit side and lower limit side of the allowable range of the acceleration degree at the time of acceleration and deceleration when the set value of the target following distance is small compared to when it is large.

Specifically, the vehicle according to the present embodiment has, as driving modes, a first driving mode and a second driving mode by which an allowable range of acceleration degree at the time of acceleration or deceleration is expanded at the upper limit side and lower limit side compared with the first driving mode. The electronic control unit 6 (control device) is configured to set the driving mode to the second driving mode when the set value of the target following distance is less than or equal to a predetermined value.

Due to this, when the set value of the target following distance at the time of tracking is small, that is, when it is considered that the vehicle user is emphasizing the effect of improvement of fuel economy due to the reduction of the air resistance over riding comfort of the vehicle, the driving mode of the vehicle can be set to a driving mode with an allowable range of the acceleration degree at the time of acceleration or deceleration which is relatively broad and when the set value of the target following distance at the time of tracking is large, that is, when it is considered that the vehicle user is emphasizing riding comfort of the vehicle, the driving mode of the vehicle can be set to a driving mode with an allowable range of the acceleration degree at the time of acceleration or deceleration which is relatively narrow. For this reason, it is possible to suitably control the vehicle behavior at the time of tracking so that the effect which the vehicle user emphasizes is obtained.

Above, embodiments of the present disclosure were explained, but the above embodiments only show some of the examples of application of the present disclosure and are not intended to limit the technical scope of the present disclosure to the specific constitutions of the above embodiments.

For example, in the above embodiments, the computer program run in the electronic control unit 6 may also be provided in a form recorded in a computer readable portable recording medium such as a semiconductor memory, magnetic recording medium, or optical recording medium.

Further, in the above embodiments, the allowable range of the acceleration degree at the time of acceleration or deceleration of the second driving mode is expanded at both of the upper limit side and lower limit side compared with the first mode, but it is sufficient that the allowable range be expanded at least at one of the upper limit side and lower limit side compared with the first mode.

1. A vehicle comprising a control device configured to control a vehicle behavior for driver assistance or automated driving, wherein
the control device is configured to:
set the driving mode at the time of tracking based on the target following distance at the time of tracking making the host vehicle follow a tracked object at the time of driver assistance or the time of automated driving when performing that tracking; and
set the driving mode to a driving mode by which the allowable range of the acceleration degree at the time of acceleration or deceleration is expanded at least at one of the upper limit side and lower limit side when the set value of the target following distance is small compared to when the target following distance is large.

2. The vehicle according to claim 1,
having, as driving modes, a first driving mode and a second driving mode by which an allowable range of the acceleration degree at the time of acceleration or deceleration is expanded at an upper limit side and lower limit side compared with the first driving mode, wherein
the control device is configured to set the driving mode to the second driving mode when the set value of the target following distance is less than or equal to a predetermined value.

3. The vehicle according to claim 2, wherein
the predetermined value is made the shortest distance among the following distances which can be set as the target following distance.

4. A control method for a vehicle by a control device configured to control a vehicle behavior for driver assistance or automated driving, wherein
the control methods includes:
setting the driving mode at the time of tracking based on the target following distance at the time of tracking making the host vehicle follow a tracked object at the time of driver assistance or the time of automated driving when performing that tracking; and
setting the driving mode to a driving mode by which the allowable range of the acceleration degree at the time of acceleration or deceleration is expanded at least at one of the upper limit side and lower limit side when the set value of the target following distance is small compared to when the target following distance is large.
